(19) United States
(12) Patent Application Publication
(10) Pub. No.: US 2010/0204380 A1
(43) Pub. Date: Aug. 12, 2010

(54) Thermally Conductive Polymer Composites and Articles Made Using the Same

(75) Inventors: Sung Jun KIM, Uiwang-si (KR); Chang Min HONG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries Inc., Gumi-si (KR)

(21) Appl. No.: 12/764,305

(22) Filed: Apr. 21, 2010

Related U.S. Application Data
(63) Continuation-in-part of application No. PCT/KR2007/007010, filed on Dec. 31, 2007.

(30) Foreign Application Priority Data
Oct. 23, 2007 (KR) 10-2007-0106602

(51) Int. Cl. C08K 3/08

(52) U.S. Cl. 524/440; 524/441

(57) ABSTRACT

A thermally conductive polymer composite that can have excellent thermal conductivity with a low content of a metal filler and capable of reinforcing mechanical strength by effectively compositing a thermally conductive filler is provided. The polymer composite includes 30 to 85% by volume of a crystalline polymer resin, 5 to 69% by volume of mixed metal fillers, and 1 to 10% by volume of a low-melting-point metal.

### CROSS-REFERENCE TO RELATED APPLICATIONS

This application is a continuation-in-part of International Application No. PCT/KR2007/007010, filed Dec. 31, 2007, pending, which designates the U.S., published as WO 2009/054567, and is incorporated herein by reference in its entirety, and claims priority therefrom under 35 USC Section 120. This application also claims priority under 35 USC Section 119 from Korean Patent Application No. 10-2007-0106602, filed Oct. 23, 2007, in the Korean Intellectual Property Office, the entire disclosure of which is also incorporated herein by reference.

### FIELD OF THE INVENTION

The present invention relates to a polymer composite including mixed metal fillers and a low-melting-point metal.

### BACKGROUND OF THE INVENTION

The range and amount of a thermally conductive material tend to increase with increased power consumption of electric/electronic parts or products.

Metals have been used as a thermally conductive material. However, metals have low moldability, productivity and parts designability. Because of these limitations, there have been many efforts to develop a substitute material for metals.

Thermally conductive polymers have been proposed as a substitute for metals. Thermally conductive polymer materials can have the advantages of providing high productivity in injection molding methods and allowing precise design. However, thermally conductive polymer material substitutes for metal can have a maximum thermal conductivity of about 10 [W/mK]. Thus, metals are still used for parts requiring high thermal conductivity.

Currently, there is focus on developing thermally conductive polymer materials that can provide optimal thermal conductivity using a minimum amount of thermally conductive fillers to ensure fluidity for injection molding and an appropriate level of physical properties.

With regard to thermally conductive polymer composites, Japanese Patent Application Laid-Open Publication No. 2006-22130 discloses a composite including a crystalline polymer, an inorganic powder having a poor compatibility with a low-melting-point metal and metal powder, and a fibrous reinforcing material. The thermal conductor therein is composed of the inorganic powder having a poor compatibility with a low-melting-point metal and metal powder, and thus takes a different approach as compared to the present invention, in which the thermal conductivity is increased by maximizing the contact efficiency between all thermal conductive fillers. In addition, the matrix, i.e., the crystalline polymer, contains a high content of materials having poor compatibility with each other, which may have a negative influence on the physical properties, and there is a disadvantage that additional glass fibers must be added to reinforce the properties.

Japanese Patent Application Laid-Open Publication No. 2006-257174 discloses a thermally conductive polymer composite using expandable graphite and general graphite in a ratio of 1/9 to 5/5, respectively in this order. This invention relates to a composite which increases thermal conductivity by increasing the contact probability between graphite by adjusting the ratio of the expandable graphite and general graphite. However, since the invention uses graphite, there are disadvantages in that the viscosity of the material itself is high and the material may easily break. Moreover, there is a problem of slurping causing the graphite to come off from the surface of the material.

U.S. Pat. No. 6,048,919 discloses a composite including a thermally conductive filler having an aspect ratio of at least 10:1 and a thermally conductive filler having an aspect ratio of less than 5:1 in a volume ratio of 30 to 60% and 25 to 60%, respectively. In this invention, the contact probability between the thermally conductive fillers is lower than the optimized contact probability between fibrous and sheet fillers and low-melting-point metal of the present invention. Moreover, this invention does not take into consideration the physical properties of the composite.

### SUMMARY OF THE INVENTION

In accordance with an aspect of the present invention, a thermally conductive polymer composite is provided comprising 30 to 85% by volume of a crystalline polymer resin, 5 to 69% by volume of mixed metal fillers, and 1 to 10% by volume of a low-melting-point metal having a solidus temperature lower than a melting point temperature of the crystalline polymer resin.

The thermally conductive polymer composite of the invention can have excellent thermal conductivity even with a reduced amount of metal filler. The thermally conductive polymer composite of the invention can also have good physical properties, such as mechanical strength.

Conventionally, thermally conductive polymer materials have been developed primarily by compositing a polymer and a thermally conductive filler. To date, other methods for significantly increasing the thermal conductivity of a polymer material other than polymer/thermally conductive filler composite have much to be desired.

Generally a polymer material is a thermal insulator having a thermal conductivity of 0.1 to 0.4 [W/mK]. When compositing a polymer material and a thermally conductive filler, the maximum thermal conductivity that can obtained is 10 [W/mK]. However, when using a high content or amount of the thermally conductive filler to obtain such a high thermal conductivity, the viscosity of the polymer composite can rapidly increase and the mechanical properties can be rapidly reduced. Thus, it can be difficult to realize the actual benefits of such a thermally conductive polymer material.

Further, the theoretical thermal conductivity of the polymer composite calculated according to Fourier's Law is generally significantly different from the actual thermal conductivity of the polymer composite. Specifically, the maximum value of the thermal conductivity of the polymer composite calculated according to Fourier's Law is much higher than the actual thermal conductivity of the polymer composite, in which the actual physical property of the composite is generally set between the maximum and the minimum value of the theoretically calculated values. That is, for some reason, the actual thermal conductivity of the polymer composite is far from reaching the thermal conductivity of the thermal conductive filler to be added. The main cause of this difference is that in the thermally conductive polymer composite, especially at the interface of the thermally conductive filler and polymer, a considerable amount of Phonon is scattered, thereby interfering with heat transfer. Thus, it is assumed that the function of the thermally conductive filler is significantly limited in the composite.

However, the present inventors have conducted many experiments. As a result, they have suggested that the interfacial Phonon scattering of the thermally conductive filler/polymer may cause the significant difference for a polymer composite with a low filler content (filler content in an amount insufficient to generate filler/filler contact). However, the interfacial Phonon scattering of the thermally conductive filler/polymer is not a major cause of reduced thermal conductivity in the case of a polymer composite with a high filler content (filler content in an amount sufficient to generate filler/filler contact) to obtain high thermal conductivity. Instead, the inventors assumed that the Phonon scattering at the interface of the thermally conductive filler/thermally conductive filler is the major cause of reduced thermal conductivity.

That is, the Phonon scattering at the interface of the thermally conductive filler/thermally conductive filler causes significant reduction of the conductivity of the thermally conductive filler itself.

Even though the Phonon scattering is generated at the interface of the thermally conductive filler/thermally conductive filler, the thermal conductivity is still higher than in the case where the filler is isolated inside the polymer composite. Thus, an important factor for developing a thermally conductive polymer composite is to increase contact probability between the thermally conductive fillers. That is, since the thermal conductivity of the polymer itself is largely lower than that of the thermally conductive filler, it is thought that the level of Phonon scattering at the interface of thermally conductive filler/polymer will not have a significant effect on the whole polymer composite.

Consequently, minimizing the Phonon scattering at the interface of filler/filler and maximizing the contact probability between the fillers at the same time may be important factors for developing the thermally conductive polymer composite. However, the filler/filler interface is a characteristic of a material rather than a factor that can be controlled. Thus, maximizing the contact probability of the filler/filler can be the major factor for developing the thermally conductive polymer composite.

In this regard, the present inventors have searched for a material composition for maximizing the contact probability between the fillers. As a result, they have developed a thermally conductive polymer composite that can have excellent thermal conductivity and mechanical strength, which comprises 30 to 85% by volume of a crystalline polymer resin, 5 to 69% by volume of mixed metal fillers, and 1 to 10% by volume of a low-melting-point metal having a solidus temperature lower than a melting point temperature of the crystalline polymer resin.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

First, constituent components forming the resin composition of the present invention are examined.

(A) Crystalline Polymer Resin

The polymer resin used as a constituent component of the thermal conductive polymer composite of the present invention is a crystalline polymer resin. This is because the crystalline resin has higher conductivity than a non-crystalline resin. Thus, the final thermal conductivity of the polymer composite varies depending on the thermal conductivity of the polymer resin to be used.

Examples of the crystalline polymer resin include but are not limited to polyphenylene sulfide (PPS), liquid crystal polymer (LCP), polyamide (PA), syndiotactic polystyrene (sPS), polyetheretherketone (PEEK), polyethylene terephthalate (PET), polybutylene terephthalate (PBT), polyoxymethylene (POM), polypropylene (PP) and polyethylene (PE), alone or in combination of two or more.

The thermally conductive polymer composite of the invention can include the crystalline polymer resin in an amount of 30 to 85% by volume, for example 50 to 79% by volume, based on the final content (the final total volume or amount) of the thermally conductive polymer composite. When the amount of the crystalline polymer resin exceeds 85% by volume, it can be difficult to ensure that the composite has a thermal conductivity suitable for use in applications requiring thermal conductivity. When the amount of the crystalline polymer resin is less than 30% by volume, it can be difficult to prepare the polymer composite.

(B) Mixed Metal Fillers

Another constituent component of the thermally conductive polymer composite of the present invention is mixed metal fillers, in which metals having two or more different shapes are mixed. The mixed metal fillers are used to maximize contact between the thermally conductive fillers.

Fibrous metal fillers in a shape capable of reinforcing physical properties and sheet metal fillers having high contact probability between fillers can be mixed in a volume ratio of 9:1 to 1:9, for example a volume ratio of the fibrous fillers and sheet fillers of 4:6 to 6:4. This can promote contact efficiency between the thermally conductive fillers.

The fibrous or sheet metal fillers are made of metals with excellent thermal conductivity such as aluminum, copper, zinc, magnesium, nickel, silver, chromium, iron, molybdenum or stainless steel, or a mixture thereof. The metals can be made into fibrous or sheet shapes using methods such as cutting, milling, melt dispersing, electrolyzing, grinding or chemical reduction.

The fibrous metal fillers can have an aspect ratio (length/diameter) of 10 to 10,000, for example 50 to 300. When the aspect ratio exceeds 10,000, it can be difficult to prepare the composite. When the aspect ratio is less than 10, the contact probability between the fillers and physical properties thereof may be inefficient.

The sheet metal fillers can have an aspect ratio (length/thickness) of 10 to 100,000, for example 50 to 500. When the aspect ratio exceeds 100,000, the packing factor in the resin can be greatly reduced such that there may be a problem of impregnation in the resin. When the aspect ratio is less than 10, the contact probability between the fillers may be inefficient.

The thermally conductive polymer composite of the present invention can include the mixed metal fillers in an amount of 5 to 69% by volume, for example 20 to 45% by volume, based on the final content (the final total volume or amount) of the thermally conductive polymer composite. When the content of the mixed metal fillers exceeds 69% by volume, it can be difficult to process the polymer composite preparation. Even if the composite is prepared, it can be difficult to process the composite using typical injection molding because of it significantly high viscosity. When the content of mixed metal fillers is less than 5% by volume, it can be difficult to provide the composite with a desired thermal conductivity suitable for use in applications requiring thermal conductivity.

(C) Low-Melting-Point Metal

A low-melting-point metal, as another constituent component of the thermal conductive polymer composite of the present invention, is a solid solution composed of two or more metal elements. The low-melting-point metal can be, for example, a metal solid solution whose solidus temperature is lower than the melting point temperature of the above-mentioned crystalline polymer.

For example, a low-melting-point metal whose solidus temperature is 20° C. or more lower than the melting point temperature of the crystalline polymer can allow effective networking between the fillers and can be convenient for making the composite. The solidus temperature of the low-melting-point metal can also be 100° C. or more higher than the environment in which the polymer composite is used for product stability.

The low-melting-point metal can include tin, bismuth, or lead, or a mixture thereof, as a majority component (for example, the low-melting-point metal can include tin, bismuth, or lead in an amount greater than 50% of the total weight of the low-melting-point metal). The low-melting-point metal can further include another metal which is different from the majority metal component as a minority component (for example, the low-melting-point metal can include a different metal in an amount less than 50% of the total weight of the low-melting-point metal). By adjusting the content of these major components and a metal element such as copper, aluminum, nickel, or silver, the physical properties such as solidus temperature, liquidus temperature, or mechanical strength can be controlled.

Examples of the low-melting-point metal include low-melting-point metals containing tin, bismuth, lead, or a mixture thereof in an amount of 89% by weight or more and less than 100% by weight and copper, aluminum, nickel, silver, or a mixture thereof in an amount exceeding 0% by weight and up to 11% by weight or less. However, as long as the solidus temperature is lower than the melting point temperature of the crystalline polymer, the low-melting-point metal is not limited to the low-melting-point metal having the above-mentioned constituent components and constitution ratio of the components.

For example, when using aluminum as a metal filler, aluminum can also be a component of the solid solution. As another example, when using copper as a metal filler, copper can also be a component of the solid solution.

The low-melting-point metal can include tin instead of bismuth or lead in view of its more eco-friendly nature.

The thermally conductive polymer composite can include the low-melting-point metal in an amount of 1 to 10% by volume, for example 1 to 5% by volume, of the final content (the final total volume or amount) of the thermally conductive polymer composite. When the content of the low-melting-point metal exceeds 10% by volume, the low-melting-point metal can have high interfacial energy with the resin, which can cause difficulties in impregnation/dispersion. When the content of the low-melting-point metal is less than 1% by volume, the function of allowing networking between the fillers may be insignificant, which can reduce the effect of improving the contact probability between the fillers.

The thermally conductive polymer composite of the present invention may contain additives such as talc, silica, mica, alumina, or glass fibers. By adding these inorganic fillers, physical properties such as mechanical strength and heat deflection temperature can be improved. Moreover, the resin composition of the present invention may further contain a UV absorbent, a heat stabilizer, an antioxidant, a flame retardant, a lubricant, a dye and/or a pigment. The amounts and methods of using these additives are widely known to those skilled in this field of art.

The parts produced from the thermally conductive polymer composite of the present invention can have high thermal conductivity so that heat generated from general exothermic parts can be effectively radiated. For example, when the polymer composite is used in heat radiation of general power or electric/electronic equipment, or heat radiation of integrated circuits such as LSI or CPU used in electronic equipment such as personal computers or digital video disc drive, it may give the products very good credibility.

According to the present invention, the polymer composite having excellent thermal conductivity and mechanical strength can be obtained even when the content of the thermally conductive filler has relatively low thermal conductivity. Thus, the polymer composite can be efficiently used as a material for heat radiation parts of electric/electronic parts. Therefore, using the thermally conductive polymer composite of the present invention can improve the stability or lifespan of exothermic electric/electronic parts or the electric/electronic equipment including the same.

Hereinafter, the components and functions of the present invention will be described in greater detail by way of appropriate Examples of the present invention, but these Examples are not intended to limit the present invention in any way. The contents, which are not described herein, are technically analogized by those skilled in the art to which the present invention pertains without difficulty, and therefore, a description thereof will be omitted.

A detailed description of the constituent components used in the Examples and Comparative Examples of the present invention is as follows.

(A) Crystalline Polymer

In the Examples of the present invention, the PPS (polyphenylene sulfide) Ryton PR-35 available from Cheveron Phillips Chemical Company LLC is used as a crystalline polymer resin. The zero viscosity measured at 315.5° C. under nitrogen atmosphere is 1000 [P].

(B) Mixed Metal Fillers

Among the mixed metal fillers used in the Examples of the present invention, the fibrous metal fillers are aluminum having an average particle diameter of 40 μm, an average length of 2.5 mm, and an aspect ratio (length/diameter) of 62.5, and the sheet metal fillers are aluminum having an average thickness of 350 nm, an average length of 40 μm, and an aspect ratio (diameter/thickness) of 114.

(C) Low-Melting-Point Metal

The low-melting-point metal used in Examples of the present invention is a tin/aluminum low-melting-point metal having tin as a major component. Specifically, a tin/aluminum solid solution whose solidus temperature is 228° C., in which the content of tin is 99.7% by weight and the content of aluminum is 0.3% by weight, is used.

### Examples 1 to 6

Using the above-mentioned constituent components, the thermal conductive polymer composites with the formulations shown in Examples 1 to 6 of Table 1 are prepared using a typical process for preparing a polymer composite such as a twin screw extruder and injection machine. The thermal conductivity is measured by guarded heat flow method, and the mechanical properties are measured based on ASTM D790. The results are presented in Table 1.

TABLE 1
(Unit: vol %)

| | Examples | | | | | |
|---|---|---|---|---|---|---|
| | 1 | 2 | 3 | 4 | 5 | 6 |
| PPS | 60 | 60 | 60 | 60 | 60 | 60 |
| Fibrous | 19.5 | 28.5 | 19 | 9.5 | 18.5 | 17.5 |
| Aluminum | | | | | | |
| Sheet Aluminum | 19.5 | 9.5 | 19 | 28.5 | 18.5 | 17.5 |
| Low-Melting- | 1 | 2 | 2 | 2 | 3 | 5 |
| Point Metal | | | | | | |
| (Sn/Al) | | | | | | |
| Thermal | 2.70 | 2.73 | 2.99 | 2.85 | 3.05 | 3.33 |
| Conductivity | | | | | | |
| [W/mK] | | | | | | |
| Flexural | 123,000 | 124,000 | 121,000 | 100,000 | 115,000 | 91,000 |
| Modulus | | | | | | |
| [kgf/cm²] | | | | | | |
| Flexural | 850 | 830 | 810 | 750 | 790 | 650 |
| Strength | | | | | | |
| [kgf/cm²] | | | | | | |

### Comparative Examples 1 to 6

Polymer composites containing carbon fiber, graphite or aluminum powder in addition to the above-mentioned constituent components are prepared using a typical process for preparing a polymer composite such as a twin screw extruder and injection machine. Their specific formulations, thermal conductivity and mechanical properties are presented in Table 2. The thermal conductivity and mechanical properties are measured in the same manner as in Examples 1-6.

TABLE 2
(Unit: vol %)

| | Comparative Examples | | | | | |
|---|---|---|---|---|---|---|
| | 1 | 2 | 3 | 4 | 5 | 6 |
| PPS | 60 | 60 | 60 | 60 | 60 | 60 |
| Fibrous | 20 | 40 | — | — | — | — |
| Aluminum | | | | | | |
| Sheet | 20 | — | 40 | — | — | — |
| Aluminum | | | | | | |
| Carbon Fiber¹⁾ | — | — | — | 40 | — | — |
| Graphite²⁾ | — | — | — | — | 40 | — |
| Aluminum | — | — | — | — | — | 40 |
| Powder³⁾ | | | | | | |
| Thermal | 2.64 | 2.38 | 2.49 | 2.13 | 4.0 | 2.3 |
| Conductivity | | | | | | |
| [W/mK] | | | | | | |
| Flexural | 123,000 | 130,000 | 106,500 | 190,000 | 85,000 | 101,000 |
| Modulus | | | | | | |
| [kgf/cm²] | | | | | | |
| Flexural | 860 | 1,000 | 700 | 2,010 | 460 | 630 |
| Strength | | | | | | |
| [kgf/cm²] | | | | | | |

¹⁾Pitch-based carbon fiber having a diameter of 11 μm and a length of 6 mm
²⁾Artificial graphite having an average particle diameter of 80 μm
³⁾Aluminum powder having an average particle diameter of 40 μm

From the above results, mechanical properties such as flexural modulus or flexural strength are evaluated to be excellent as more fibrous aluminum is included. By increasing the content of the low-melting-point metal, the contact efficiency between the fillers is maximized, thereby having positive effects on the thermal conductivity. Meanwhile, with regard to thermal conductivity, the thermal conductivity is most excellent when a volume ratio of the fibrous and sheet aluminum is 5:5.

In the case of carbon fiber, which is a preferred conventional thermally conductive filler, the results show that mechanical properties are excellent, but thermal conductivity decreased. In the case of graphite, thermal conductivity is excellent, but mechanical properties deteriorated significantly. It is also well known, in the case of graphite, that the viscosity of the polymer composite is increased, which causes slurping.

Consequently, by maximizing the contact between the thermally conductive fillers by using the mixed metal fillers and the low-melting-point metal according to the present invention, a polymer composite having excellent thermal conductivity with a relatively small content of the thermally conductive filler can be obtained, to thereby solve the problem of high viscosity of conventional thermal conductive polymers. In addition, by compositing effectively in a form of thermal conductive filler, the present invention can overcome low mechanical strength and resolve problems such as slurping by not using graphite-based thermal conductive filler.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermally conductive polymer composite comprising:
30 to 85% by volume of a crystalline polymer resin;
5 to 69% by volume of mixed metal fillers; and
1 to 10% by volume of a low-melting-point metal having a solidus temperature lower than a melting point temperature of the crystalline polymer resin.

2. The polymer composite according to claim 1, wherein the crystalline polymer resin comprises polyphenylene sulfide (PPS), liquid crystal polymer (LCP), polyamide (PA), syndiotactic polystyrene (sPS), polyetheretherketone (PEEK), polyethylene terephthalate (PET), polybutylene terephthalate (PBT), polyoxymethylene (POM), polypropylene (PP), polyethylene (PE), or a combination thereof.

3. The polymer composite according to claim 1, wherein the mixed metal filler comprises fibrous metal fillers and sheet metal fillers.

4. The polymer composite according to claim 3, comprising the fibrous metal fillers and sheet metal fillers in a ratio (volume ratio) of 9:1 to 1:9.

5. The polymer composite according to claim 1, wherein the mixed metal fillers comprise aluminum, copper, zinc, magnesium, nickel, silver, chromium, iron, molybdenum, stainless steel, or a mixture thereof.

6. The polymer composite according to claim 3, wherein the fibrous metal filler has an aspect ratio (length/diameter) of 10 to 10,000.

7. The polymer composite according to claim 3, wherein the sheet metal filler has an aspect ratio (length/thickness) of 10 to 100,000.

8. The polymer composite according to claim 1, wherein the low-melting-point metal is a metal solid solution comprising two or more metal elements.

9. The polymer composite according to claim 1, wherein the low-melting-point metal is a metal solid solution prepared with two or more metals selected from the group consisting of tin, bismuth, lead, copper, aluminum, nickel and silver.

10. A mold produced from a thermally conductive polymer composite of claim 1.
